(19) United States
(12) Patent Application Publication
(10) Pub. No.: US 2025/0041945 A1
(43) Pub. Date: Feb. 6, 2025

(54) MACHINE TOOL FOR MACHINING WORKPIECES AND METHODS OF OPERATION THEREOF

(71) Applicant: Fives Landis Limited, Keighley (GB)

(72) Inventor: Philip NEWISS, Keighley (GB)

(21) Appl. No.: 18/718,350

(22) PCT Filed: Dec. 12, 2022
(86) PCT No.: PCT/GB2022/053175

§ 371 Date: Jun. 10, 2024

(30) Foreign Application Priority Data
Dec. 16, 2021 (GB) 2118230.8

(51) Int. Cl. B23B 1/00; B23B 31/00

(52) U.S. Cl. CPC B23B 1/00; B23B 31/00

(57) ABSTRACT

A machine tool for machining two workpieces comprises a machine base, a first tool mount, first and second workpiece mounts with respective drives, and a controller arranged to control the first and second workpiece mount drives so as to bring first and second workpieces carried by the first and second workpiece mounts, respectively, into engagement with a tool carried by the first tool mount.

### FIELD OF THE DISCLOSURE

The present disclosure relates to a machine tool for machining workpieces. This includes but is not limited to machine tools and machining processes involving the use of a grinding wheel and/or a rotating workpiece.

### BACKGROUND TO THE DISCLOSURE

In machining processes, material is removed from a workpiece by a tool. The tool is advanced into the workpiece until it reaches a position where the workpiece is at its final finished size. For example, in abrasive or grinding machining processes, the material is removed by a tool which may be in the form of a rotating grinding wheel.

### SUMMARY OF THE DISCLOSURE

The present disclosure provides a machine tool for machining two workpieces, the machine tool comprising:
a machine base having a machine base reference plane;
a first tool mount for carrying a tool;
a first workpiece mount for carrying a first workpiece and rotating the first workpiece about a first axis of rotation;
a second workpiece mount for carrying a second workpiece and rotating the 25 second workpiece about a second axis of rotation;
a first workpiece mount drive for moving the first workpiece mount relative to the machine base;
a second workpiece mount drive for moving the second workpiece mount relative to the machine base; and
a controller arranged to control the first and second workpiece mount drives so as to bring first and second workpieces carried by the first and second workpiece mounts, respectively, into engagement with a tool carried by the first tool mount.

Accordingly, the machine tool may be arranged to machine two workpieces simultaneously or sequentially using the same tool. This may be achieved in a single machining process, that is, after one set-up procedure without further operator intervention.

In comparison to a known machine tool for machining a single workpiece with a tool, machine tools described herein may provide up to twice the output rate of finished workpieces. This may be achieved with a machine tool having a significantly smaller footprint than two known machine tools for carrying out the same process. Furthermore, the number of components and amount of material used to fabricate the machine tool may be substantially reduced in comparison to that required for two existing machine tools. For example, only a single tool dresser may be needed, whereas two machine tools would each require their own tool dressing station.

Further savings may be provided for users of the machine tool in terms of reduced power consumption and/or reduced use of coolant. Also, the amount of machine operator time required may also be reduced.

The first tool mount may be arranged to continuously rotate a tool such as a grinding wheel, for example, through complete revolutions during a machining operation to remove material from a workpiece in contact with the grinding wheel.

In preferred examples, the controller is arranged to control the first and second workpiece mount drives independently, so as to bring first and second workpieces carried by the first and second workpiece mounts, respectively, into engagement with a tool carried by the first tool mount.

The controller may be arranged to control the first and second workpiece mount drives so as to bring first and second workpieces carried by the first and second workpiece mounts, respectively, into engagement with a tool carried by the first tool mount, such that the first and second workpieces are machined simultaneously by a tool carried by the first tool mount.

Alternatively, the controller may be arranged to control the first and second workpiece mount drives so as to bring first and second workpieces carried by the first and second workpiece mounts, respectively, into engagement with a tool carried by the first tool mount, such that the first and second workpieces are machined separately by a tool carried by the first tool mount. The first and second workpieces may be machined one after the other by a tool carried by the first tool mount.

A machine tool may be provided wherein, in a first mode of operation, the controller is arranged to control the first and second workpiece mount drives so as to bring first and second workpieces carried by the first and second workpiece mounts, respectively, into engagement with a tool carried by the first tool mount, such that the first and second workpieces are machined simultaneously by a tool carried by the first tool mount, and
in a second mode of operation, the controller is arranged to control the first and second workpiece mount drives so as to bring first and second workpieces carried by the first and second workpiece mounts, respectively, into engagement with a tool carried by the first tool mount, such that the first and second workpieces are machined separately by a tool carried by the first tool mount.

The first workpiece mount may be arranged to rotate the first workpiece through complete revolutions about a first axis of rotation.

The second workpiece mount may be arranged to rotate the second workpiece through complete revolutions about a second axis of rotation.

The first and second axes of rotation may be parallel to the machine base reference plane.

The first workpiece mount may be movable relative to the machine base by the first workpiece mount drive along a first workpiece mount linear reference axis to adjust its position relative to the machine base.

The second workpiece mount may be movable relative to the machine base by the first workpiece mount drive along a second workpiece mount linear reference axis to adjust its position relative to the machine base.

The first and second workpiece mount linear reference axes may be parallel to each other. They may be parallel to the machine base reference plane.

The first workpiece mount linear reference axis may be the only linear degree of freedom provided between the first workpiece mount and the machine base and/or the second workpiece mount linear reference axis may be the only linear degree of freedom provided between the second workpiece mount and the machine base. This may facilitate more accurate control of the respective mount positions relative to the machine base, in comparison to the use of multiple, stacked linear guideways.

The first workpiece mount may be movable relative to the machine base along a first workpiece mount linear lateral reference axis, which is perpendicular to the first workpiece mount linear reference axis and parallel to the machine base reference plane. In this example, motion of the first workpiece mount along the first workpiece mount linear reference axis and the first workpiece mount linear lateral reference axis may be the only linear degrees of freedom provided between the first workpiece mount and the machine base.

The movement of the first workpiece mount along first workpiece mount linear lateral reference axis may facilitate lateral adjustment of the location of the first workpiece relative to the second workpiece to alter their alignment prior to simultaneous machining of both of the workpieces by the same tool.

At least one of the first and second workpiece mounts may be rotatable relative to the machine base about a respective workpiece mount rotational axis which is perpendicular to the machine base reference plane to adjust the respective mount's rotational position relative to the machine base. In this way, the angle at which one or both of the workpieces is presented to a tool carried by a tool mount may be altered and controlled. A mechanism may be provided to enable a required angle of presentation of a workpiece to be selected.

The first tool mount may be movable relative to the machine base along a first tool mount linear reference axis to enable a tool carried by the first tool mount to engage different axial locations along the first and second workpieces. The first tool mount linear reference axis may be the only linear degree of freedom provided between the first tool mount and the machine base. The first tool mount may be driven along the first tool mount linear reference axis by a first tool mount linear drive. The first tool mount linear reference axis may be parallel to the machine base reference plane.

In some preferred implementations, the first tool mount is rotatable relative to the machine base about a first tool mount rotational axis which is perpendicular to the reference plane of the machine base. This may allow the angle at which the tool is presented to the workpiece to be varied and controlled. A mechanism may be provided to enable a required angle of presentation of the tool to be selected.

The machine tool may include a second tool mount for carrying a tool. In this way, a second tool may be utilised without needing to interrupt a machining operation to remove one tool from a tool mount and replace it with another.

The second tool mount may be movable relative to the machine base along a second tool mount linear reference axis to enable a tool carried by the second tool mount to engage different axial locations along the first and second workpieces. The second tool mount linear reference axis may be the only linear degree of freedom provided between the first tool mount and the machine base. The second tool mount may be driven along the second tool mount linear reference axis by a second tool mount linear drive. The first tool mount linear reference axis may be parallel to the machine base reference plane and may be parallel to the first tool mount linear reference axis.

The second tool mount may be rotatable relative to the machine base about a second tool mount rotational axis which is perpendicular to the reference plane of the machine base. This may allow the angle at which the tool carried by the second tool mount is presented to the workpiece to be varied and controlled. A mechanism may be provided to enable a required angle of presentation of the tool to be selected.

The first tool mount and/or the second tool mount may be arranged to carry two or more tools. In some examples, one or both of the tool mounts may be rotatable about a respective axis which is perpendicular to the machine base reference plane to select a tool carried thereon for use in a subsequent machining operation.

The first tool mount may carry a tool in the form of a grinding wheel having first and second discrete grinding portions which define respective different grinding surface profiles. In examples of the present machine tool, a first workpiece may be ground using the first grinding portion whilst a second workpiece is being ground using the second grinding portion.

The present disclosure also provides a method of machining two workpieces using a machine tool as described herein.

A method of machining two workpieces using a machine tool as described herein may include the steps of:
rotating the first workpiece about a first axis of rotation;
rotating the second workpiece about a second axis of rotation;
rotating at least one of the first and second workpiece mounts relative to the machine base about a respective workpiece mount rotational axis such that the first and second axes of rotation are non-parallel when projected onto the machine base reference plane; and
machining the first and second workpieces simultaneously with a tool carried by the first tool mount.

Accordingly, the angle at which one or both of the workpieces is presented to the tool may be adjusted to facilitate a wider range of machining processes.

A machining method using a grinding wheel having first and second discrete grinding portions which define respective different grinding surface profiles may include a step of grinding a first workpiece using the first grinding portion of the grinding wheel and simultaneously grinding a second workpiece using the second grinding portion of the grinding wheel. Such a process may be used in grinding two workpieces to form the same components or to form two different components.

### BRIEF DESCRIPTION OF THE DRAWINGS

Known machine configurations and examples of the present disclosure will now be described with reference to the accompanying schematic drawings, wherein:

FIGS. 1 and 2 show plan views of two known grinding machine configurations;

FIGS. 3 to 5 show plan, side and perspective views of a machine tool according to an example of the present disclosure;

FIGS. 6 to 12 show plan views of further machine tools according to examples of the present disclosure; and

FIG. 13 is a perspective view of a dual profile grinding wheel for use in examples of the present disclosure.

### DETAILED DESCRIPTION

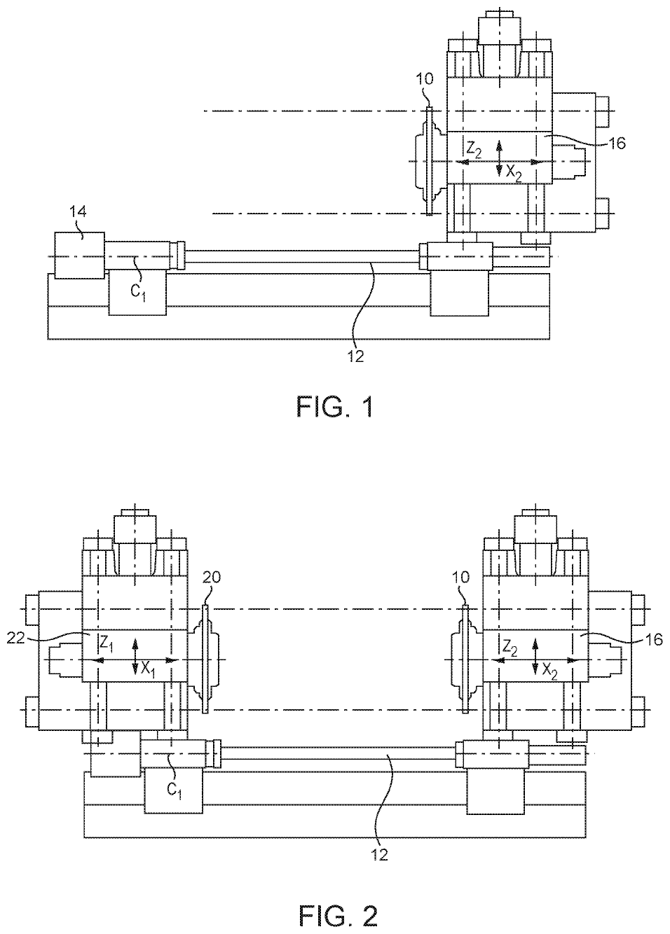

Two known grinding machine configurations are illustrated in FIGS. 1 and 2. In the machine of FIG. 1, a grinding wheel 10 is used to machine a single workpiece 12. The workpiece is rotated about a longitudinal axis C1 by a rotary drive 14. The grinding wheel is mounted on a spindle drive 16 which is movable relative to the machine base by two linear drives. The linear drives move the spindle drive along respective axes X2 and Z2, with X2 orientated perpendicular to axis C1 and Z2 parallel to axis C1.

The grinding machine of FIG. 2 includes a second grinding wheel 20 mounted on a respective spindle drive 22. In a similar manner to spindle drive 16, spindle drive 22 is movable by two corresponding linear drives along mutually perpendicular axes X1 and Z1.

Thus, movement of the grinding wheels 10 and 20 along the X1, X2, Z1 and Z2 axes enables the wheels to access any axial positions along the workpiece 12. Their positions along their respective X axes are used to control the diameter of ground features.

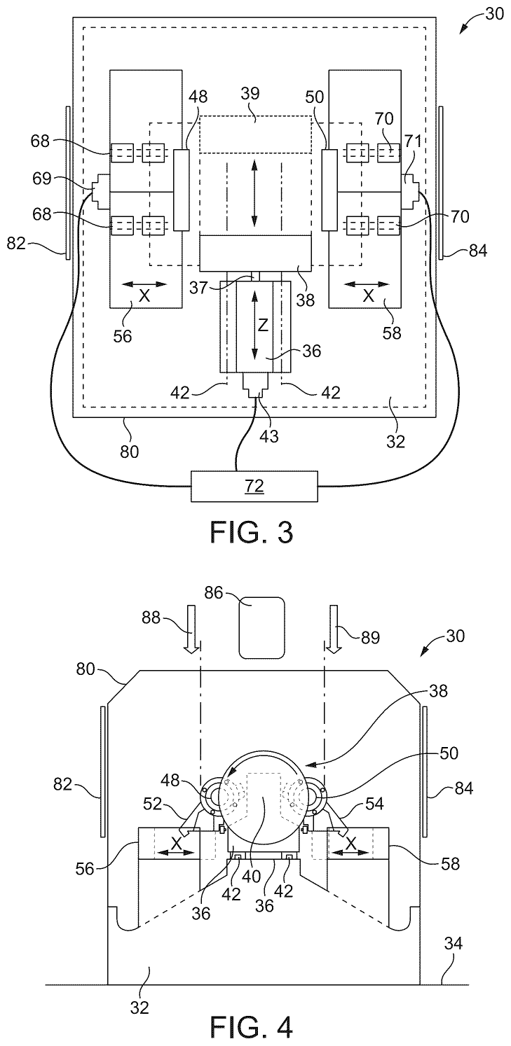

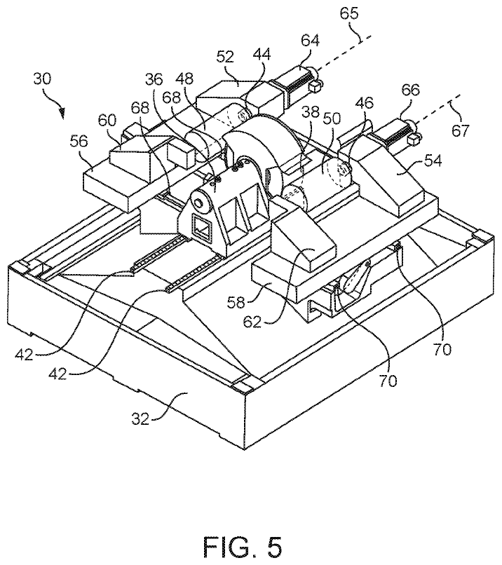

An example of a machine tool 30 according to the present disclosure is shown in FIGS. 3 to 5. It includes a machine bed or base 32 having a horizontal reference plane 34. The machine base carries a grinding wheel wheelhead 36 which includes a first tool mount in the form of a driven shaft 37. A grinding wheel 38 is mounted on the driven shaft and the wheelhead is operable to rotate the grinding wheel about an axis 40 which is parallel to the machine base reference plane 34. The wheelhead is carried by a pair of linear guideways 42 to enable the wheelhead move along axis Z which is parallel to the grinding wheel axis 40 and the machine base reference plane 34. A motorised linear drive 43 is provided to control the position of the wheelhead along the Z axis. A second location 39 for the grinding wheel along the Z axis is indicated in FIG. 3 in dashed outline.

The grinding wheel 38 may have a grinding surface formed of cubic boron nitride (CBN) or other materials such as aluminium oxide or silicon carbide. A greater depth of grinding material may be provided on the wheel to accommodate increased wear resulting from the grinding of two workpieces by the same wheel.

The machine tool also includes two workpiece mounts 44 and 46. One end of each of the workpieces 48 and 50 is mounted on respective mounts 44 and 46. Each mount is carried by a respective headstock 52, 54 at one end which is in turn carried on a respective table 56, 58. The opposite end of each workpiece is supported by a respective tailstock 60, 62, which is also carried by a respective table 56, 58. Each headstock includes a respective rotary drive 64, 66 for rotating the respective workpiece mount 44, 46 about axes 65, 67 which are parallel to each other, axis Z and the machine base reference plane 34. Each table 56, 58 is mounted on a respective pair 68, 70 of linear guideways to enable each table to be moved along an axis X by a respective motorised drive 69, 71 in order to feed the respective workpiece towards grinding wheel axis 40. The axis X is perpendicular to axis 40 and parallel to the machine base reference plane 34.

The drives of the machine are controlled by a controller 72.

The table drives are used to bring their respective workpieces into engagement with the grinding wheel in order to plunge grind the surface of the workpieces. Each table drive is operable independently of the other to facilitate grinding of one workpiece at a time and/or simultaneous grinding of two workpieces by the grinding wheel 38.

The machine tool includes an enclosure 80 which is carried by the machine base 32 and surrounds the grinding region. The enclosure includes two access doors 82 and 84 to allow access to each table 56 and 58 and the surrounding regions. A single gantry loader 86 is used to load workpieces into the machine tool. Dual loader arms (not shown) carried by the gantry loader are used to insert and remove workpieces in the directions indicated by arrows 88 and 90.

The machine tool of FIGS. 3 to 5 has three linear machine drives (providing linear motion along two X axes and one Z axis) and three rotary machine drives (providing rotation about grinding wheel axis 40 and two workpiece axes 65, 67) only. The guideways associated with the linear axes may be precision linear guideways and may use hydrostatic or linear rail technology, for example.

In a modified version of the machine shown in FIGS. 3 to 5, a second wheelhead carrying a second grinding wheel may be provided which is movable along the Z axis and located adjacent to the opposite ends of the workpieces to wheelhead 36. This provides further flexibility, enabling selection of one of two grinding wheels for use in a grinding process.

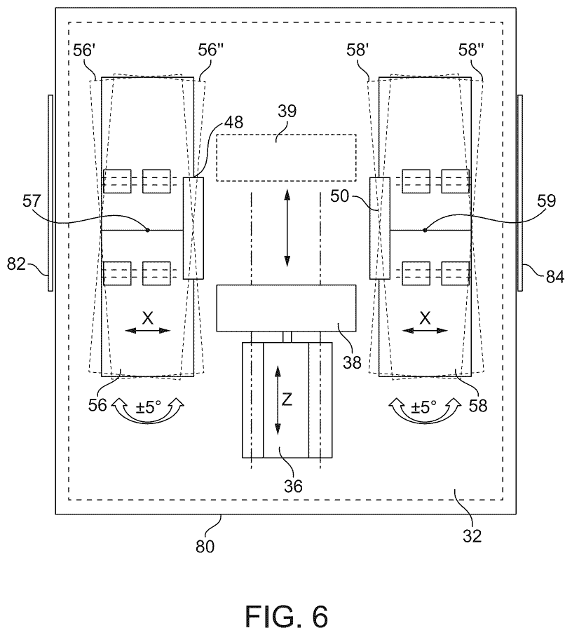

FIGS. 6 to 9 show the machine tool having a similar configuration to that shown in FIGS. 3 to 5 except that the machine tool has been modified to incorporate additional rotational degrees of freedom in association with the tables 56 and 58. The tables are carried by the machine base in such a way that their rotational orientation relative to respective axes of rotation 57, 59 which are perpendicular to the machine base reference plane can be adjusted. The range of motion available in this manner is illustrated in the example of FIG. 6 using dashed outlines 48′ and 48″ to show different orientations of the table 48 and the dashed outlines 50′ and 50″ to show different orientations of the table 50. Each table may be rotatable by up to around 5° either side of an orientation in which the axis of rotation of the respective workpiece is parallel to the Z axis of the grinding wheel. This serves to increase the versatility machine tool, enabling it to adjust the angle of the workpiece at which it is plunge ground using the grinding wheel 38 by moving the workpiece along the X axis.

A rotational position adjustment mechanism may be provided in association with each table for adjusting the position of the respective table about its axis of rotation 57, 59. Each mechanism may include a drive for moving the respective table about its axis.

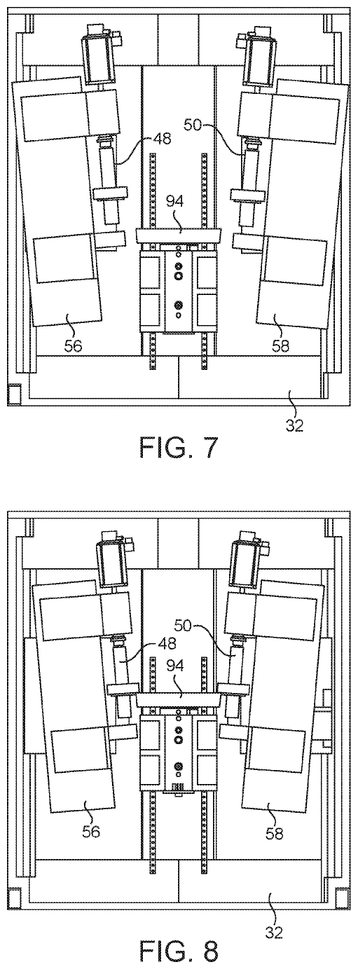

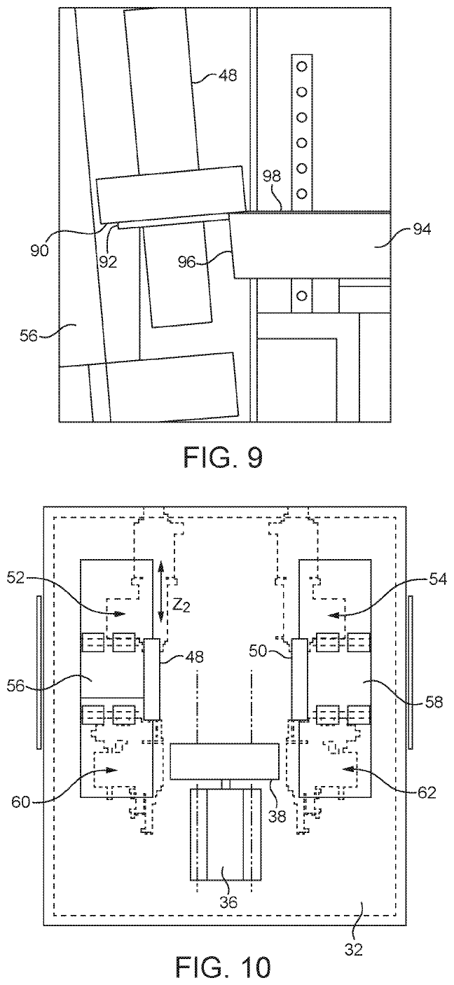

A grinding process utilising this ability is illustrated in FIGS. 7 to 9. It involves grinding workpieces 48 and 50 which include a sidewall surface 90 that extends perpendicular to the longitudinal axis of the workpiece and an adjacent cylindrical surface 92 (see FIG. 9). It may be desirable to grind both of these surfaces simultaneously using an angled grinding wheel 94. Wheel 94 includes two peripheral grinding surfaces, namely a circumferential surface 96 which meets a side surface 98. FIGS. 7 and 8 illustrate movement of grinding wheel 94 along its Z axis combined with movement of angled tables 56 and 58 along their respective X axes so as to bring the grinding wheel into simultaneous engagement with both workpieces 48 and 50 in order to grind respective sidewall and cylindrical surfaces 90, 92 as shown in FIG. 8, and the enlarged view of part of FIG. 8 shown in FIG. 9. This method of grinding a cylindrical surface and an adjacent sidewall may more evenly distribute wear over the grinding wheel in comparison to a perpendicular plunge grind using a grinding wheel having a cylindrical circumferential grinding surface with a sidewall grinding surface perpendicular thereto.

An optional addition to examples of machine tools described herein is a further linear degree of freedom in association with one of the tables 56, 58 to facilitate adjustment of the position of one of the workpieces relative to the machine base in a direction perpendicular to its X axis, and parallel to the machine base reference plane. The direction of this linear motion is indicated in FIG. 10 by axis Z2. This may provide fine adjustment of the relative positioning of the workpieces in a direction parallel to the Z axis of the grinding wheel prior to simultaneous grinding of the two workpieces by the same grinding wheel.

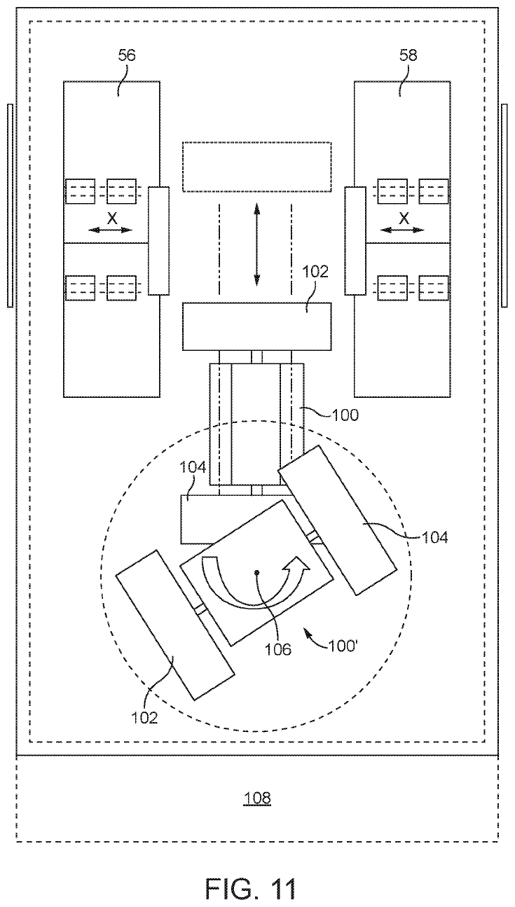

A further modification is shown in FIG. 11. In this machine tool, a wheelhead 100 includes a turret which is rotatable relative to the machine base about an axis 106 perpendicular to the machine base reference plane. The wheelhead may include a drive for rotating the turret about the axis 106 and controlling its rotational position relative thereto. Two wheel drive spindles are carried by the turret, each having a mount for attachment to a respective grinding wheel 102, 104. This enables selection of one of the two grinding wheels for use in a grinding operation. The wheelhead may be retracted away from the workpieces along its Z axis and its turret may be rotated (as illustrated by the intermediate position marked 100′ in FIG. 11) to bring the other grinding wheel 104 into the grinding position with respect to its rotational axis 106. Grinding wheel 104 may then be moved into the grinding region by driving the wheelhead along the Z axis.

The machine tool shown in FIG. 11 may include an automatic grinding wheel changing facility 108 to provide automated replacement of a worn wheel and/or switching between different wheel configurations.

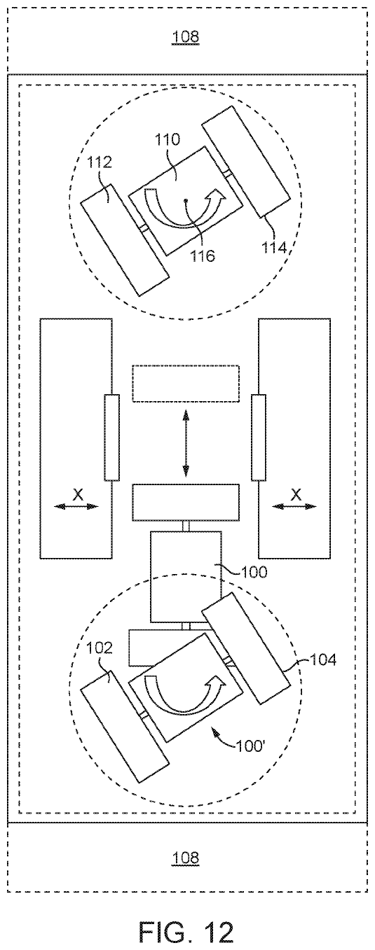

A further development of the machine tool shown in FIG. 11 is depicted in FIG. 12. It includes a second wheelhead 110 located towards an opposite end of the machine base to the wheelhead 100. As in the case of wheelhead 100, wheelhead 110 includes a rotatable turret which carries two wheel drive spindles. Wheelhead 110 may include a drive for rotating its turret about an axis 116 and controlling its rotational position relative thereto. Each of these spindles has a mount for attachment to a respective grinding wheel 112, 114. Wheelhead 110 is also mounted on linear guideways for movement along the Z axis so as to move a selected grinding wheel into the grinding region and move it relative to the workpieces. The machine tool configuration of FIG. 12 therefore provides further versatility, with up to four grinding wheels provided on respective spindles and readily available for use in a grinding operation. In this example, an automatic grinding wheel changing facility 108 may be provided adjacent to both of the wheelheads 100 and 110.

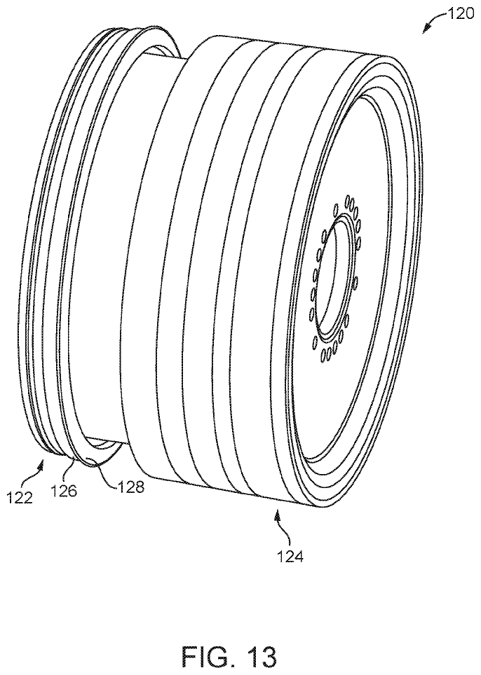

One or more of the grinding wheels used in examples of machine tools described herein may be in the form of a “dual profile wheel”. A wheel 120 of this type is depicted in FIG. 13. Wheel 120 has first and second discrete grinding portions 122, 124 which define respective different grinding surface profiles. Grinding portion 122 comprises a cylindrical grinding surface 126 adjacent to a sidewall grinding surface 128. Grinding portion 124 comprises a plurality of cylindrical grinding surfaces. It will be appreciated that a range of different combinations of grinding portions may be provided on a dual profile wheel to suit particular requirements. A dual profile wheel may be used in a machine tool as described herein to grind simultaneously one workpiece using a first grinding portion and a second workpiece using a second grinding portion.

It will be appreciated that references herein to perpendicular or parallel relative orientations may be interpreted as defining perpendicular or parallel relationships between components within practical tolerances.

1. A machine tool for machining two workpieces, the machine tool comprising:
a machine base having a machine base reference plane;
a first tool mount for carrying a tool;
a first workpiece mount for carrying a first workpiece;
a second workpiece mount for carrying a second workpiece;
a first workpiece mount drive for moving the first workpiece mount relative to the machine base;
a second workpiece mount drive for moving the second workpiece mount relative to the machine base; and
a controller arranged to control the first and second workpiece mount drives so as to bring the first and second workpieces carried by the first and second workpiece mounts, respectively, into engagement with the tool carried by the first tool mount.

2. The machine tool of claim 1, wherein the controller is arranged to control the first and second workpiece mount drives so as to bring the first and second workpieces carried by the first and second workpiece mounts, respectively, into engagement with the tool carried by the first tool mount, such that the first and second workpieces are machined simultaneously by the tool carried by the first tool mount.

3. The machine tool of claim 1, wherein the controller is arranged to control the first and second workpiece mount drives so as to bring the first and second workpieces carried by the first and second workpiece mounts, respectively, into engagement with the tool carried by the first tool mount, such that the first and second workpieces are machined separately by the tool carried by the first tool mount.

4. The machine tool of claim 2, wherein, in a first mode of operation, the controller is arranged to control the first and second workpiece mount drives so as to bring the first and second workpieces carried by the first and second workpiece mounts, respectively, into engagement with the tool carried by the first tool mount, such that the first and second workpieces are machined simultaneously by the tool carried by the first tool mount, and in a second mode of operation, the controller is arranged to control the first and second workpiece mount drives so as to bring the first and second workpieces carried by the first and second workpiece mounts, respectively, into engagement with the tool carried by the first tool mount, such that the first and second workpieces are machined separately by the tool carried by the first tool mount.

5. The machine tool claim 1, wherein at least one of the first and second workpiece mounts is rotatable relative to the machine base about a respective workpiece mount rotational axis which is perpendicular to the machine base reference plane.

6. The machine tool of claim 1, wherein the first tool mount is movable relative to the machine base along a first tool mount linear reference axis.

7. The machine tool of claim 1, wherein the first tool mount is rotatable relative to the machine base about a first tool mount rotational axis which is perpendicular to the machine base reference plane.

8. The machine tool of claim 1, wherein the first tool mount is arranged to carry two or more tools.

9. The machine tool of claim 1, including a second tool mount for carrying a tool.

10. The machine tool of claim 9, wherein the second tool mount is movable relative to the machine base along a second tool mount linear reference axis.

11. The machine tool of claim 9, wherein the second tool mount is rotatable relative to the machine base about a second tool mount rotational axis which is perpendicular to the machine base reference plane.

12. The machine tool of claim 9, wherein the second tool mount is arranged to carry two or more tools.

13. The machine tool of claim 1, wherein the tool is in the form of a grinding wheel having first and second discrete grinding portions which define respective different grinding surface profiles.

14. A method of machining two workpieces using the machine tool of claim 1.

15. The method of claim 14, including the steps of:
rotating the first workpiece about a first axis of rotation;
rotating the second workpiece about a second axis of rotation;
rotating at least one of the first and second workpiece mounts relative to the machine base about a respective workpiece mount rotational axis such that the first and second axes of rotation are non-parallel when projected onto the machine base reference plane; and
machining the first and second workpieces simultaneously with the tool carried by the first tool mount.

16. The method of claim 14, wherein the tool is in the form of a grinding wheel having first and second discrete grinding portions which define respective different grinding surface profiles, the method further including a step of grinding the first workpiece using the first grinding portion of the grinding wheel and simultaneously grinding the second workpiece using the second grinding portion of the grinding wheel.

17. The machine tool of claim 3, wherein, in a first mode of operation, the controller is arranged to control the first and second workpiece mount drives so as to bring the first and second workpieces carried by the first and second workpiece mounts, respectively, into engagement with the tool carried by the first tool mount, such that the first and second workpieces are machined simultaneously by the tool carried by the first tool amount, and
in a second mode of operation, the controller is arranged to control the first and second workpiece mount drives so as to bring the first and second workpieces carried by the first and second workpiece mounts, respectively, into engagement with the tool carried by the first tool mount, such that the first and second workpieces are machined separately by the tool carried by the first tool mount.
